(19) United States
(12) Patent Application Publication
(10) Pub. No.: US 2022/0375033 A1
(43) Pub. Date: Nov. 24, 2022

(54) IMAGE PROCESSING METHOD, DATA PROCESSING METHOD, IMAGE PROCESSING APPARATUS AND PROGRAM

(71) Applicant: NIPPON TELEGRAPH AND TELEPHONE CORPORATION, Tokyo (JP)

(72) Inventors: Satoshi SUZUKI, Musashino-shi, Tokyo (JP); Motohiro TAKAGI, Musashino-shi, Tokyo (JP); Ryuichi TANIDA, Musashino-shi, Tokyo (JP); Mayuko WATANABE, Musashino-shi, Tokyo (JP); Hideaki KIMATA, Musashino-shi, Tokyo (JP)

(73) Assignees: NIPPON TELEGRAPH AND TELEPHONE CORPORATION, Tokyo (JP); NIPPON TELEGRAPH AND TELEPHONE CORPORATION, Tokyo (JP)

(21) Appl. No.: 17/773,952

(22) PCT Filed: Nov. 15, 2019
(86) PCT No.: PCT/JP2019/044909

§ 371 Date: May 3, 2022

(51) Int. Cl. G06T 3/40; G06N 3/08; H04N 19/88

(52) U.S. Cl. CPC G06T 3/4046; G06N 3/08; H04N 19/88

(57) ABSTRACT

A deep feature generation unit (20) inputs an inference image from an input layer (21) of a neural network, performs forward propagation in the neural network, and outputs a plurality of frame images that each include a channel image and are aligned in a predetermined first sequence as intermediate output values from an intermediate layer (22), which is a predetermined layer that is not an output layer of the neural network. A rearrangement unit (30) rearranges the frame images aligned in the first sequence into frame images in a second sequence based on a predetermined rearrangement sequence from the first sequence to the second sequence, such that a total of degrees of similarity between adjacent frame images in the second sequence is greater than a total of degrees of similarity between adjacent frame images in the first sequence. A coding unit (41) compresses and codes the plurality of the frame images rearranged in the second sequence using a compression coding method based on the correlation between the frames.

### TECHNICAL FIELD

The present invention relates to an image processing method, a data processing method, an image processing apparatus, and a program.

### BACKGROUND ART

In recent years, the accuracy of machine learning technology, and in particular, technology such as identification and detection of a subject in an image and region splitting using a convolutional neural network (CNN), has been remarkably improved. Technology that uses machine learning to promote automation of visual steps in various tasks has been attracting attention.

If an imaging device is in an edge terminal environment such as a mobile environment, several approaches are conceivable as candidates for processing a captured image. Mainly an approach of transmitting a captured image to a cloud and processing it in the cloud (cloud approach) and an approach of completing the processing with only the edge terminal (edge approach) are conceivable. In addition to these typical approaches, an approach called Collaborative Intelligence has been proposed in recent years.

Collaborative Intelligence is an approach of distributing a computational load between the edge and the cloud. The edge device performs image processing using a CNN partway, and transmits intermediate outputs (deep features) of the CNN, which are the result. Then, the cloud server side performs the remaining processing. This Collaborative Intelligence has been shown to have the potential to surpass the cloud approach and edge approach in terms of power and latency (see NPL 1).

### CITATION LIST

### Non-Patent Literature

[NPL 1] Y. Kang, J. Hauswald, C. Gao, A. Rovinski, T. Mudge, J. Mars, and L. Tang, “Neurosurgeon: Collaborative intelligence between the cloud and mobile edge”, 2017
[NPL 2] ITU-T Recommendation, “H.265: High Efficiency Video Coding”, 2013.
[NPL 3] H. Choi, I. Bajic, “Deep feature compression for collaborative object detection”, 2018.
[NPL 4] S. Suzuki, H. Shouno, “A study on visual interpretation of network in network”, 2017.

### SUMMARY OF THE INVENTION

### Technical Problem

The present invention relates to a coding technique for compressing deep features in Collaborative Intelligence. That is, it is desired that the coding technique targeted by the present invention maintains the accuracy of the deep features even if the deep features are compressed, using the image processing accuracy at the time of compressing the deep features as a reference.

Mainly two schemes are conceivable as deep feature compression schemes. The first is a scheme of aligning deep features for each channel and compressing them as an image. The second is a scheme of treating each channel as one frame and compressing a set of a plurality of frames as a moving image. A moving image compression scheme such as H.265/HEVC (see NPL 2) is commonly used as a compression scheme (see NPL 3). One problem of the present invention is to improve the compression rate obtained when using the scheme of compressing as a moving image.

If the deep features are to be compressed as a moving image, it can be expected that the compression efficiency will be improved by using the correlation between frames through interframe prediction. However, in the conventional technique, no consideration is given to the correlation between channels when performing training of the CNN. That is, no consideration is given to the correlation between frames. Accordingly, the efficiency of interframe prediction for CNN channels is not as good as when interframe prediction is performed on natural images. In such a situation, if high compression is performed, there is concern that distortion will increase and the accuracy will significantly decrease.

As a solution, a method of rearranging the coding sequence of the frames is also conceivable. For example, it is conceivable to use a method in which the mean square error (MSE) between any two frames is used as an index and the MSE between adjacent frames is reduced. If this method is used, it is also expected that the correlation between adjacent frames will increase in the rearranged deep features, and the prediction efficiency of interframe prediction will increase. However, since the deep features are generated for each input image, there is concern about another problem in which the optimum rearrangement sequence needs to be calculated for each input image and thus the amount of calculation increases significantly. Furthermore, since the rearrangement sequence is not fixed, in order to return the rearrangement sequence to normal on the receiving side, in addition to the deep features, the rearrangement sequence also needs to be transmitted at the same time each time. That is, there is also a problem in that overhead cannot be ignored.

The present invention aims to provide an image processing method, a data processing method, an image processing apparatus, and a program according to which it is not necessary to determine a rearrangement sequence each time when deep features are compressed and transmitted.

### Means for Solving the Problem

The image processing method according to one aspect of the present invention is an image processing method including: a step of inputting an inference image from an input layer of a neural network, performing forward propagation in the neural network, and acquiring an output value of a neuron in an intermediate layer, which is a predetermined layer that is not an output layer of the neural network, as an intermediate output value aligned in a predetermined first sequence; a step of rearranging the intermediate output value aligned in the first sequence into a second sequence based on a predetermined rearrangement sequence from the first sequence to the second sequence such that a total of degrees of similarity of adjacent intermediate output values in the second sequence is greater than a total of degrees of similarity of adjacent intermediate output values in the first sequence; and a step of regarding the intermediate output value as a frame, and performing compression coding on a plurality of the intermediate output values rearranged into the second sequence, using a compression coding method based on a correlation between frames.

Also, one aspect of the present invention is a data processing method including: a step of inputting data to be processed from an input layer of a neural network, performing forward propagation in the neural network, and acquiring an output value of a neuron in an intermediate layer, which is a predetermined layer that is not an output layer of the neural network, as an intermediate output value aligned in a predetermined first sequence; a step of rearranging the intermediate output value aligned in the first sequence into a second sequence based on a predetermined rearrangement sequence from the first sequence to the second sequence such that a total of degrees of similarity of adjacent intermediate output values in the second sequence is greater than a total of degrees of similarity of adjacent intermediate output values in the first sequence; and a step of regarding the intermediate output value as a frame, and performing compression coding on a plurality of the intermediate output values rearranged into the second sequence, using a compression coding method based on a correlation between frames.

Also, one aspect of the present invention is an image processing apparatus including: a deep feature generation unit configured to input an inference image from an input layer of a neural network, perform forward propagation in the neural network, and output an output value of a neuron in an intermediate layer, which is a predetermined layer that is not an output layer of the neural network, as an intermediate output value aligned in a predetermined first sequence; a rearrangement unit configured to rearrange the intermediate output value aligned in the first sequence into a second sequence based on a predetermined rearrangement sequence from the first sequence to the second sequence such that a total of degrees of similarity of adjacent intermediate output values in the second sequence is greater than a total of degrees of similarity of adjacent intermediate output values in the first sequence; and a coding unit configured to regard the intermediate output value as a frame, and perform compression coding on a plurality of the intermediate output values rearranged into the second sequence, using a compression coding method based on a correlation between frames.

Also, one aspect of the present invention is a program for causing a computer to function as an image processing apparatus including: a deep feature generation unit configured to input an inference image from an input layer of a neural network, perform forward propagation in the neural network, and output an output value of a neuron in an intermediate layer, which is a predetermined layer that is not an output layer of the neural network, as an intermediate output value aligned in a predetermined first sequence; a rearrangement unit configured to rearrange the intermediate output value aligned in the first sequence into a second sequence based on a predetermined rearrangement sequence from the first sequence to the second sequence such that a total of degrees of similarity of adjacent intermediate output values in the second sequence is greater than a total of degrees of similarity of adjacent intermediate output values in the first sequence; and a coding unit configured to regard the intermediate output value as a frame, and perform compression coding on a plurality of the intermediate output values rearranged into the second sequence, using a compression coding method based on a correlation between frames.

### Effects of the Invention

According to the present invention, it is not necessary to determine the rearrangement sequence each time due to using a predetermined rearrangement sequence when compressing deep features.

### BRIEF DESCRIPTION OF DRAWINGS

FIG. 1 is a block diagram showing an overview of an overall functional configuration of the first embodiment.

FIG. 2 is a block diagram showing a functional configuration used in the case where at least some of the functions of the image processing system according to the present embodiment are realized as a transmission-side apparatus and a reception-side apparatus.

FIG. 3 is a flowchart for illustrating an overall operation procedure of a pre-training unit in a deep feature compression method according to the present embodiment.

FIG. 4 is a flowchart for illustrating an operation procedure of a similarity degree estimation unit of the present embodiment.

FIG. 5 is a flowchart for illustrating an operation procedure of a rearrangement sequence determination unit of the present embodiment.

FIG. 6 is a flowchart for illustrating an overall operation procedure of units other than the pre-training unit in processing performed using the deep feature compression method according to the present embodiment.

FIG. 7 is a flowchart for illustrating operations of a deep feature generation unit of the present embodiment.

FIG. 8 is a flowchart for illustrating operations of a rearrangement unit of the present embodiment.

FIG. 9 is a flowchart for describing operations of a realignment unit of the present embodiment.

FIG. 10 is a flowchart for illustrating operations of a cloud image processing unit of the present embodiment.

FIG. 11A is a reference example showing a frame image in the case where an image for a plurality of channels is compressed and coded as an image of one frame.

FIG. 11B is an example (scheme of the first embodiment) showing a frame image in the case where interframe predictive coding is performed using an image for one channel as an image of one frame.

FIG. 11C is an example (scheme of the second embodiment) showing a frame image in the case where interframe predictive coding is performed on a plurality of frame images while using images for a plurality of channels as an image of one frame.

FIG. 12 is a block diagram showing an overview of an overall functional configuration of the second embodiment.

FIG. 13 is a flowchart for illustrating operations of the rearrangement sequence determination unit in the case where imaging and animation of the present embodiment are performed at the same time.

FIG. 14 is a block diagram showing an example of a hardware configuration for realizing each of the first embodiment and the second embodiment.

FIG. 15 is a graph showing the difference in the effect of compression coding between the case of using the first embodiment and the case of using the conventional technique.

### DESCRIPTION OF EMBODIMENTS

### First Embodiment

Next, an embodiment of the present invention will be described with reference to the drawings. In the present embodiment, image processing using a deep neural network (DNN) is performed. The multi-layer neural network used for image processing is typically a convolutional neural network (CNN).

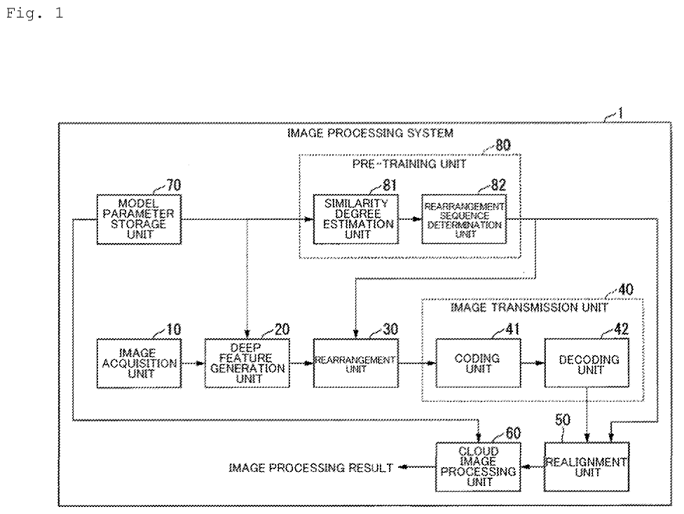

FIG. 1 is a block diagram showing an overview of the overall functional configuration of the present embodiment. As shown in the drawings, an image processing system 1 of the present embodiment has a configuration including an image acquisition unit 10, a deep feature generation unit 20, a rearrangement unit 30, an image transmission unit 40, a realignment unit 50, a cloud image processing unit 60, a model parameter storage unit 70, and a pre-training unit 80. Each of these functional units can be realized by, for example, a computer and a program. Also, each functional unit has a storage means, as needed. The storage means is, for example, a variable on a program or a memory allocated through execution of a program. Also, a non-volatile storage means such as a magnetic hard disk apparatus or a solid state drive (SSD) may also be used as needed. Also, at least some of the functions of each functional unit may be realized not as a program but as a dedicated electronic circuit.

In the configuration of FIG. 1, the rearrangement sequence estimated by the pre-training unit 80 through training is used during inference (during image processing). That is, in the configuration of FIG. 1, the timing at which the pre-training unit 80 operates and the timing at which the other parts in the image processing system 1 operate are different from each other. The functions of the units are as follows.

First, the pre-training unit 80 will be described. The pre-training unit 80 determines the sequence for when the rearrangement unit 30 rearranges the frames based on training data. The realignment unit 50 performs processing that is the inverse of the rearrangement processing performed by the rearrangement unit 30. Accordingly, the rearrangement sequence determined by the pre-training unit 80 is passed also to the realignment unit 50 and used. The pre-training unit 80 includes a similarity degree estimation unit 81 and a rearrangement sequence determination unit 82.

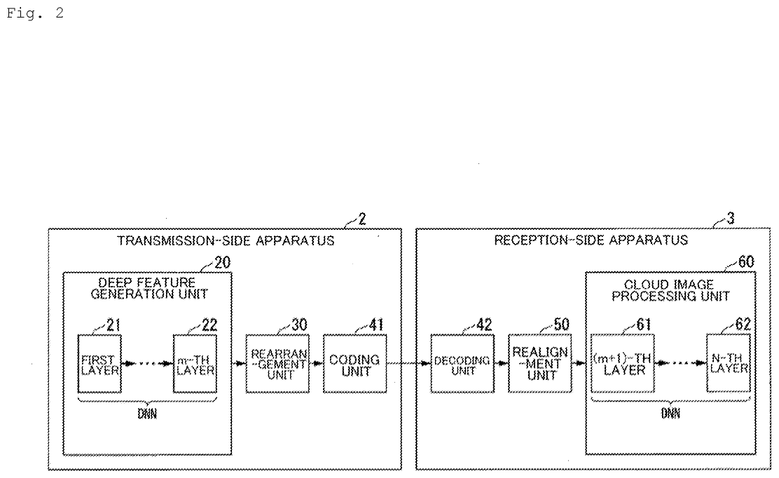

Here, the purpose of the pre-training unit 80 will be described. The pre-training unit 80 acquires a rearrangement sequence in which predetermined features present at predetermined positions in a frame are arranged in a predetermined sequence (absolute sequence). The predetermined sequence is, for example, a sequence in which the similarity between adjacent frames is maximized. By doing so, the sequence determined by the pre-training unit 80 is shared by a transmission-side apparatus 2 (FIG. 2) and a reception-side apparatus 3 (FIG. 2). This makes it possible to once again rearrange the images in the sequence prior to rearrangement, without sending a sequence for each image. This is because, for example, in a convolutional neural network such as a CNN, the output of a neuron in an intermediate layer is a value that reflects the position and features in the input image.

The similarity degree estimation unit 81 estimates and outputs the degree of similarity between channels in the deep features output by the deep feature generation unit 20. For this reason, the similarity degree estimation unit 81 acquires model parameters from the model parameter storage unit 70. By acquiring the model parameters, the similarity degree estimation unit 81 can perform processing equivalent to that of the neural networks of the deep feature generation unit 20 and the cloud image processing unit 60, respectively. The deep feature generation unit 20 and the cloud image processing unit 60 respectively correspond to the front half portion (upstream portion) and the rear half portion (downstream portion) of the multi-layer neural network. That is, the entire multi-layer neural network is split into a front half portion and a rear half portion at a certain layer. The similarity degree estimation unit 81 estimates the degree of similarity between channels for the output in the layer of the split location. The similarity degree estimation unit 81 uses training data for machine learning to estimate the degree of similarity between the channels. This training data is a set of pairs of an image input to the deep feature generation unit 20 and a correct output label output for the image. As will be described later, the similarity degree estimation unit 81 provides a Network In Network (NIN) downstream of the layer that is the output from the deep feature generation unit 20. The similarity degree estimation unit 81 performs machine learning processing using the multi-layer neural network in which this NIN is introduced and the above-described training data. The similarity degree estimation unit 81 estimates the degree of similarity between channels based on the weight of each channel obtained as a result of the machine learning processing. Here, deep features and channels will be described. A “deep feature” means the output of all neurons arranged in a desired intermediate layer. In the example of FIG. 2, it is all of the outputs of the m-th layer. A “channel” means the output of each neuron arranged in a desired intermediate layer. In this embodiment, it is thought that the output value of each neuron is regarded as a frame and an image coding method such as HEVC is applied. Note that in the second embodiment, the outputs (channel images) of at least two neurons are regarded as one frame, the number of neurons being less than the number of neurons in the desired intermediate layer. In the case of a structure in which a plurality of neurons form a set to provide an output on an image as in a CNN, the image-like output is used as a frame. The similarity degree estimation unit 81 outputs the estimated degree of similarity.

The rearrangement sequence determination unit 82 acquires the degree of similarity estimated by the similarity degree estimation unit 81. The rearrangement sequence determination unit 82 determines the rearrangement sequence based on the acquired degree of similarity between any two channels. The rearrangement sequence determined by the rearrangement sequence determination unit 82 is a sequence adjusted such that when the rearrangement unit 30 rearranges the frames, the total of the degree of similarity between adjacent frames is as large as possible.

That is, a neural network that is different from the above-described neural network is connected downstream of the intermediate layer (corresponds to the m-th layer 22 in FIG. 2), and the rearrangement sequence is determined in advance based on the weights of the different neural network, which are obtained as a result of performing training processing using training data. This “different neural network” is the above-described NIN. That is, the “different neural network” performs 1×1 convolution processing.

Next, the function of each portion of the image processing system 1 other than the pre-training unit 80 will be described.

The image acquisition unit 10 acquires an image to be subjected to image processing (inference image) and passes it to the deep feature generation unit 20. For example, the image acquisition unit 10 acquires a captured image as the inference image.

The deep feature generation unit 20 inputs the inference image from the input layer of the neural network (corresponds to the first layer 21 in FIG. 2), and performs forward propagation in the above-described neural network. Then, the deep feature generation unit 20 outputs a plurality of frame images that each include a channel image and are aligned in a predetermined first sequence as intermediate output values from an intermediate layer (corresponds to the m-th layer 22 in FIG. 2), which is a predetermined layer that is not the output layer of the neural network. In other words, the deep feature generation unit 20 inputs the inference image from the input layer of the neural network and performs forward propagation in the neural network. Then, the deep feature generation unit 20 outputs the output values of the neurons in the intermediate layer, which is a predetermined layer that is not the output layer of the above-described neural network, as intermediate output values aligned in the predetermined first sequence (can be regarded as a frame image). Note that the first sequence may be any sequence.

As one mode of realization, the deep feature generation unit 20 acquires model parameters of a multi-layer neural network model from the model parameter storage unit 70. A model parameter is a weighted parameter used when calculating an output value based on an input value in each node constituting a multi-layer neural network. The deep feature generation unit 20 performs conversion based on the above-described parameters on the inference image acquired from the image acquisition unit 10. The deep feature generation unit 20 performs forward propagation processing up to a predetermined layer (output layer serving as the deep feature generation unit 20) in the multi-layer neural network. The deep feature generation unit 20 outputs the output from that layer (intermediate output in the multi-layer neural network) as the deep features. The deep feature generation unit 20 passes the obtained deep features to the rearrangement unit 30. It is assumed that the output values of the deep features output by the deep feature generation unit 20 are treated as a frame image due to being regarded as pixel values of the frame image.

The rearrangement unit 30 rearranges the frame images aligned in the first sequence into frame images in the second sequence based on a predetermined rearrangement sequence from the first sequence to the second sequence, such that the total of the degrees of similarity between adjacent frame images in the second sequence is greater than the total of the degrees of similarity between the adjacent frame images in the first sequence. In other words, the rearrangement unit 30 rearranges the intermediate output values aligned in the first sequence into the second sequence based on the predetermined rearrangement sequence from the first sequence to the second sequence such that the total of the degrees of similarity of the adjacent intermediate output values in the second sequence is greater than the total of the degrees of similarity of the adjacent intermediate output values in the first sequence. This rearrangement sequence is determined by the rearrangement sequence determination unit 82, and the specific determination method thereof will be described later.

That is, the rearrangement unit 30 rearranges the sequence of the frames of the deep features passed from the deep feature generation unit 20 according to the rearrangement sequence acquired from the rearrangement sequence determination unit 82. The rearrangement sequence determination unit 82 determines a rearrangement sequence according to which the total of the degrees of similarity between adjacent frames after rearrangement is as large as possible. Accordingly, it is expected that the total of the degrees of similarity between adjacent frames is maximized or is as large as possible in a plurality of frames according to the sequence rearranged by the rearrangement unit 30. It may also be said that the total of the differences between the adjacent frames is minimized. The rearrangement unit 30 passes the deep features that have been rearranged as described above to a coding unit 41 in the image transmission unit 40.

The image transmission unit 40 transmits a plurality of frame images output from the rearrangement unit 30 and passes them to the realignment unit 50. The image transmission unit 40 includes the coding unit 41 and a decoding unit 42. It is envisioned that the coding unit 41 and the decoding unit 42 are at locations that are remote from each other. Information is transmitted from the coding unit 41 to the decoding unit 42, for example, via a communication network. In such a case, a transmission unit for transmitting the coded data (bit stream), which is the output of a coding unit, and a reception unit for receiving the transmitted coded data should be prepared.

The coding unit 41 compresses and codes the plurality of frame images rearranged in the second sequence using a compression coding method based on a correlation between the frames. In other words, the coding unit 41 regards the above-described intermediate output value as a frame, and compresses and codes a plurality of the intermediate output values rearranged in the second sequence using a compression coding method based on the correlation between the frames.

Specifically, the coding unit 41 acquires the rearranged deep features from the rearrangement unit 30. The coding unit 41 codes the rearranged deep features. The coding unit 41 uses a scheme of interframe predictive coding (interframe predictive coding) when performing coding. In other words, the coding unit 41 performs information compression coding using the similarity between adjacent frames. As the coding method itself, an existing technique may be used. As a specific example, HEVC (also called High Efficiency Video Coding), H.264/AVC (AVC is an abbreviation for Advanced Video Coding), or the like can be used as the coding scheme. As described above, the rearrangement unit 30 rearranges the plurality of frame images included in the deep features such that the total of the degrees of similarity between adjacent frame images is maximized or is as large as possible. Accordingly, when the coding unit 41 performs compression coding, it is expected that the effect of interframe prediction coding can be significantly obtained. In other words, it is expected that a good compression ratio can be obtained due to the coding unit 41 performing compression coding. The coding unit 41 outputs a bit stream that is the result of coding.

The bit stream output by the coding unit 41 is transmitted to the decoding unit 42 by a communication means (not shown), that is, for example, by a wireless or wired transmission/reception apparatus.

The decoding unit 42 receives the bit stream transmitted from the coding unit 41 and decodes the bit stream. The decoding processing itself corresponds to the coding scheme used by the coding unit 41. The decoding unit 42 passes the deep features obtained as a result of decoding (which may be referred to as “decoded deep features”) to the realignment unit 50.

The realignment unit 50 acquires the decoded deep features from the decoding unit 42, and returns the sequence of the frame images included in the decoded deep features to the original sequence. That is, the realignment unit 50 realigns the sequence of the frame images to the sequence prior to being rearranged by the rearrangement unit 30. At the time of this processing, the realignment unit 50 references the rearrangement sequence passed from the rearrangement sequence determination unit 82. The realignment unit 50 passes the realigned deep features to the cloud image processing unit 60.

The cloud image processing unit 60 performs multi-layer neural network processing together with the deep feature generation unit 20. The cloud image processing unit 60 performs the processing of the portion of the multi-layer neural network after (i.e., downstream of) the output layer of the deep feature generation unit 20. In other words, the cloud image processing unit 60 executes forward propagation processing, which follows the processing performed by the deep feature generation unit 20. The cloud image processing unit 60 acquires the parameters of the multi-layer neural network from the model parameter storage unit 70. The cloud image processing unit 60 inputs the rearranged deep features passed from the realignment unit 50, performs image processing based on the above-described parameters, and outputs the result of the image processing.

FIG. 2 is a block diagram showing a functional configuration of a portion of the image processing system 1 illustrated in FIG. 1. As an example, the image processing system 1 can be configured to include a transmission-side apparatus 2 and a reception-side apparatus 3, as shown in FIG. 2. Each of the transmission-side apparatus 2 and the reception-side apparatus 3 may also be referred to as an “image processing apparatus”. The transmission-side apparatus 2 includes a deep feature generation unit 20, a rearrangement unit 30, and a coding unit 41. The reception-side apparatus 3 includes a decoding unit 42, a realignment unit 50, and a cloud image processing unit 60. The functions of the deep feature generation unit 20, the rearrangement unit 30, the coding unit 41, the decoding unit 42, the realignment unit 50, and the cloud image processing unit 60 are as described already with reference to FIG. 1. Note that in FIG. 2, illustration of the model parameter storage unit 70 and the pre-training unit 80 is omitted.

The deep feature generation unit 20 internally includes the first layer 21 to the m-th layer 22 of the multi-layer neural network (the middle layers are omitted in the drawing). The cloud image processing unit 60 internally includes the (m+1)-th layer 61 to the N-th layer 62 of the multi-layer neural network (the middle layers are omitted in the drawing). Note that 1≤m≤(N−1) is satisfied. The first layer 21 is the input layer of the overall multi-layer neural network. The N-th layer 62 is the output layer of the overall multi-layer neural network. The second layer to the (N−1)-th layer are intermediate layers. The m-th layer 22 on the deep feature generation unit 20 side and the (m+1)-th layer 61 on the cloud image processing unit 60 side are logically identical layers. In this manner, one multi-layer neural network is constructed in a state of being distributed on the deep feature generation unit 20 side and the cloud image processing unit 60 side.

As a configuration example, the transmission-side apparatus 2 and the reception-side apparatus 3 can be realized as separate housings. The transmission-side apparatus 2 and the reception-side apparatus 3 may be provided at locations that are remote from each other. Also, as an example, the image processing system 1 may be constituted by a large number of transmission-side apparatuses 2 and one or a small number of reception-side apparatuses 3. The transmission-side apparatus 2 may also be, for example, a terminal apparatus having an imaging function, such as a smartphone. The transmission-side apparatus 2 may also be, for example, a communication terminal apparatus to which an imaging device is connected. Also, the reception-side apparatus 3 may be realized using a so-called cloud server.

In one example of the configuration, the communication band between the transmission-side apparatus 2 and the reception-side apparatus 3 is narrower than the communication band between the other constituent elements in the image processing system 1. In such a case, in order to improve the performance of the overall image processing system 1, it is strongly desired that the data compression rate during communication between the coding unit 41 and the decoding unit 42 is improved. The configuration of the present embodiment increases the compression rate of the data transmitted between the coding unit 41 and the decoding unit 42.

FIG. 3 is a flowchart for illustrating the overall operation procedure of the pre-training unit 80 among the deep feature compression methods according to the present embodiment. Hereinafter, the processing procedure performed by the pre-training unit 80 will be described with reference to this flowchart.

First, in step S51, the similarity degree estimation unit 81 acquires the model parameters of the multi-layer neural network from the model parameter storage unit 70.

Next, in step S52, the similarity degree estimation unit 81 performs training processing using a configuration in which a Network In Network (NIN) is provided downstream of the output layer (m-th layer 22) of the neural network in the deep feature generation unit 20 of FIG. 2. The similarity degree estimation unit 81 estimates the degree of similarity between frame images based on the weights of the NIN, which are the result of this training processing.

Next, in step S53, the rearrangement sequence determination unit 82 determines the rearrangement sequence of the frames based on the degree of similarity between the frames estimated in step S52. The rearrangement sequence is a sequence that increases the overall inter-frame correlation (total of the degrees of similarity between adjacent frames). The rearrangement sequence determination unit 82 notifies the rearrangement unit 30 and the realignment unit 50 of the determined rearrangement sequence.

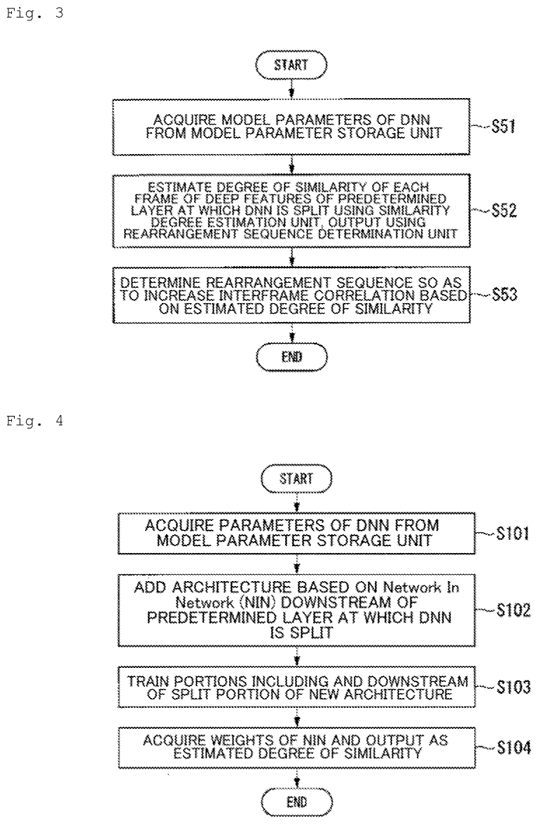

FIG. 4 is a flowchart for describing the operation procedure of the similarity degree estimation unit 81 of the present embodiment in more detail. Hereinafter, operations of the similarity degree estimation unit 81 will be described with reference to this flowchart.

First, in step S101, the similarity degree estimation unit 81 acquires the parameters of the multi-layer neural network from the model parameter storage unit 70.

Next, in step S102, the similarity degree estimation unit 81 adds another layer downstream of a predetermined layer (m-th layer 22 shown in FIG. 2) in the multi-layer neural network determined according to the parameters obtained in step S101. This other layer is a layer corresponding to the Network In Network (NIN). The NIN is filtering processing corresponding to 1×1 convolution. The NIN is known to provide a large weight to filters that extract similar features (see also NPL 4). The NIN can output a plurality of channel images, and the number of channels can be set as appropriate. It is envisioned that this number of channels is, for example, about the same as the number of split layers (here, m). However, the number of output channels does not necessarily need to be the same as the number of such layers, and the same effect is obtained in that case as well. Note that the similarity degree estimation unit 81 may randomly initialize the above-described NIN architecture based on a Gaussian distribution or the like.

Next, in step S103, the similarity degree estimation unit 81 performs machine learning of portions including and downstream of the architecture portion of the NIN added in step S102. Note that the similarity degree estimation unit 81 does not change the weights of the multi-layer network in the layers before the split layer (that is, the layers from the first layer 21 to the m-th layer 22 shown in FIG. 2). In the machine learning in this context, for example, training is performed according to which the cross-entropy loss, which is the difference between x, which is the image processing result, that is, the output from the multi-layer neural network, and y, which is a correct label provided as the training data, and the like are reduced. This cross-entropy loss is provided by the following equation (1).

[Math. 1]

L_{cross}_{_{entropy}}(x,y)=−Σy_{q} log(x_{q}) (1)

However, if the target function is appropriate for the image processing task to be performed, training may be performed using the mean square error or the like, and the same effect is obtained in this case as well.

Next, in step S104, the similarity degree estimation unit 81 outputs the estimated degree of similarity. The estimated degree of similarity in this context is the value of the weight parameter of the NIN after the training in step S103 is completed. In this embodiment, which is based on the NIN, the number of instances of co-occurrence of frames having a large weight or the like can be used as the estimated degree of similarity. The estimated degree of similarity is output as the value of the degree of similarity between any two different channels (i.e., between frames).

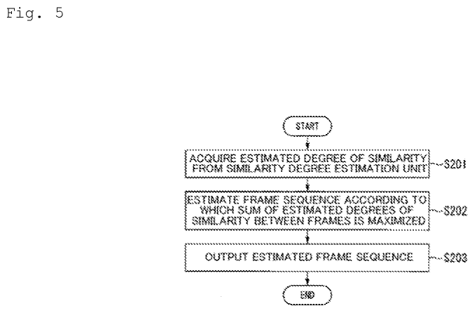

FIG. 5 is a flowchart for illustrating the operation procedure of the rearrangement sequence determination unit 82 of the present embodiment. Hereinafter, operations of the rearrangement sequence determination unit 82 will be described with reference to this flowchart.

First, in step S201, the rearrangement sequence determination unit 82 acquires the estimated degree of similarity from the similarity degree estimation unit 81. This estimated degree of similarity is output by the similarity degree estimation unit 81 in step S104 of FIG. 4.

Next, in step S202, the rearrangement sequence determination unit 82 estimates the rearrangement sequence of the frames, according to which the sum of the estimated degrees of similarity between the frames of the deep features is maximized. If the estimation of the rearrangement sequence is written more specifically, it is as follows.

The frames output from the m-th layer 22 in FIG. 2 are f(1), f(2), . . . , and f(Nf). Note that Nf is the number of frames output from the m-th layer 22. In this embodiment, one frame corresponds to one channel of the deep features. The transmission-side apparatus 2 can appropriately rearrange these frames f(1), f(2), . . . , and f(Nf) and thereafter code them. The frames according to the sequence that is the result of rearranging are fp(1), fp(2), . . . , and fp(Nf). Note that the set [f(1), f(2), . . . , f(Nf)] and the set [fp(1), fp(2), . . . , fp(Nf)] match each other. At this time, the sum S of the estimated degrees of similarity is provided by the following equation (2).

[Math. 2]

S=Σᵢ₌₁^{Nf-1}S(fp(i)fp(i+1)) (2)

Note that in equation (2), s(f(i),f(j)) is the estimated degree of similarity between an i-th frame and a j-th frame. That is, the rearrangement sequence determination unit 82 obtains an arrangement according to which the sum S of equation (2) is maximized. In general, the exact solution for the rearrangement of the frame sequence that maximizes the sum S can only be obtained through a brute-force approach. Accordingly, if the number of frames being targeted is large, it is difficult to determine this exact solution in a realistic amount of time. However, the problem of determining the rearrangement sequence is almost the same as the traveling salesman problem (TSP). The traveling salesman problem is a problem of optimizing a route from a departure city back to the departure city after traveling through all predetermined cities in a state where the travel cost between any two cities is provided in advance. That is, the traveling salesman problem is a problem of minimizing the total travel cost required for traveling. The difference between the problem of determining the rearrangement sequence in the present embodiment and the traveling salesman problem is as follows. The difference is that in the traveling salesman problem, the salesman returns to the departure city at the end, whereas in the rearrangement of the present embodiment, it is not necessary to return to the first frame at the end of the transition from frame to frame. The only influence that this difference has is that the number of terms of the evaluation function to be optimized differs by one, and this is not an essential difference. That is, the rearrangement sequence determination unit 82 can determine the optimal solution (exact solution) or a quasi-optimal solution (approximate solution) for the rearrangement sequence using a known method for solving the traveling salesman problem.

Specifically, the rearrangement sequence determination unit 82 can obtain the exact solution for the rearrangement sequence if the number of frames is relatively small. Also, the rearrangement sequence determination unit 82 can obtain an approximate solution using a method such as a local search algorithm, a simulated annealing method, a genetic algorithm, or tabu search, regardless of the number of frames.

Next, in step S203, the rearrangement sequence determination unit 82 passes the rearrangement sequence determined through the processing of step S202 to the rearrangement unit 30 and the realignment unit 50.

FIG. 6 shows a flowchart for illustrating the overall operation procedure other than the pre-training unit in the processing performed using the deep feature compression method according to the present embodiment. Hereinafter, the procedure of operations in which the image processing system 1 performs image processing according to a predetermined rearrangement sequence will be described with reference to these flowcharts.

First, in step S251, the deep feature generation unit 20 acquires an inference image from the image acquisition unit 10. Also, the deep feature generation unit 20 acquires the model parameters of the multi-layer neural network from the model parameter storage unit 70.

In step S252, the deep feature generation unit 20 calculates and outputs the deep features of the inference image. Specifically, the deep feature generation unit 20 uses the model parameters acquired in step S251 and inputs the inference image acquired in step S251 to the multi-layer neural network. The deep feature generation unit 20 performs forward propagation processing based on the above-described model parameters from the first layer 21 to the m-th layer 22 of the multi-layer neural network shown in FIG. 2, and as a result, outputs deep features from the m-th layer 22 (FIG. 2).

In step S253, the rearrangement unit 30 acquires the rearrangement sequence output from the pre-training unit 80. The rearrangement unit 30 rearranges the deep features acquired from the deep feature generation unit 20 according to this rearrangement sequence. Specifically, the rearrangement unit 30 rearranges the group of frame images output from the deep feature generation unit 20 according to the above-described rearrangement sequence. The rearrangement unit 30 once again outputs the rearranged deep features.

In step S254, the coding unit 41 codes the rearranged deep features output by the rearrangement unit 30, that is, the plurality of frame images. The coding performed here by the coding unit 41 is compression coding performed based on the correlation between frames. Also, the compression coding scheme may be lossless compression or lossy compression. The coding unit 41 uses, for example, a coding scheme used for compression coding of a moving image in the present step. As described above, the sequence of the frame images is adjusted through machine learning performed in advance by the pre-training unit 80 such that the total of the degrees of similarity between adjacent frames is maximized or an approximate solution thereof is reached. Accordingly, if the coding unit 41 performs compression coding based on the correlation between the frames, it is expected that the best compression ratio or a good compression ratio similar thereto can be realized. The coding unit 41 outputs the result of coding as a bit stream.

In step S255, the bit stream is transmitted from the coding unit 41 to the decoding unit 42. This transmission is performed by a communication means (not shown) using, for example, the Internet, another communication network, or the like. The decoding unit 42 receives the bit stream. The decoding unit 42 decodes the received bit stream and outputs the decoded deep features. When the compression coding scheme that is used is lossless compression, the deep features output by the decoding unit 42 are the same as the deep features output by the rearrangement unit 30 in the transmission-side apparatus 2.

In step S256, the realignment unit 50 performs rearrangement that is the inverse of the rearrangement performed by the rearrangement unit 30 in step S253, based on the rearrangement sequence notified by the pre-training unit 80. That is, the realignment unit 50 realigns the deep features output by the decoding unit 42 in the sequence used prior to the rearrangement.

In step S257, the cloud image processing unit 60 performs forward propagation processing of the remaining portion of the multi-layer neural network based on the realigned deep features output by the realignment unit 50. That is, the cloud image processing unit 60 inputs the realigned deep features to the (m+1)-th layer 61 shown in FIG. 2 and causes forward propagation to the N-th layer 62 to be performed. Then, the cloud image processing unit 60 outputs the image processing result, which is, in other words, the output from the N-th layer 62 of FIG. 2.

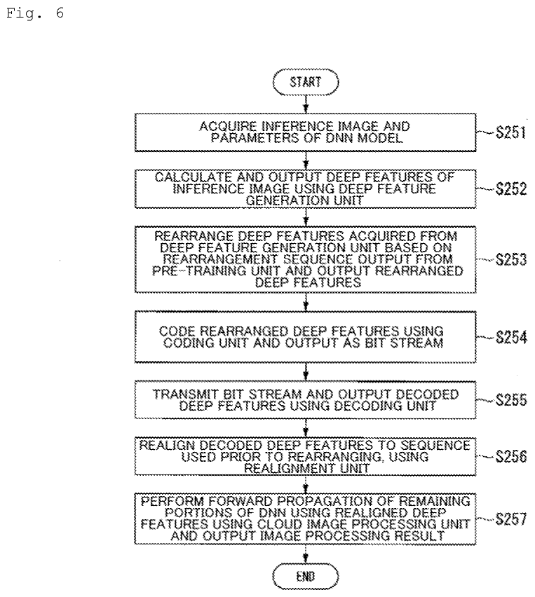

FIG. 7 is a flowchart showing a procedure of processing performed by the deep feature generation unit 20. FIG. 7 illustrates a portion of the procedure shown in FIG. 6 in more detail.

First, in step S301, the deep feature generation unit 20 acquires an inference image from the image acquisition unit 10.

Next, in step S302, the deep feature generation unit 20 acquires the model parameters of the multi-layer neural network from the model parameter storage unit 70.

Next, in step S303, the deep feature generation unit 20 inputs the inference image acquired in step S301 to the multi-layer neural network. The data of the inference image is subjected to forward propagation up to the m-th layer (FIG. 2), which is the predetermined split layer.

Next, in step S304, the deep feature generation unit 20 outputs the value (output value from the m-th layer 22) obtained as a result of the forward propagation processing performed in step S303 as a deep feature.

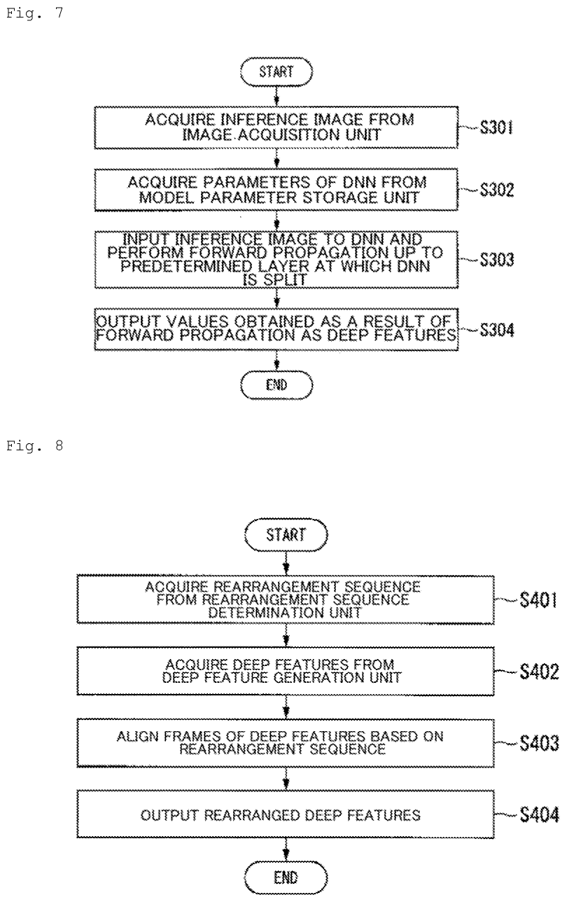

FIG. 8 is a flowchart showing a procedure of processing performed by the rearrangement unit 30. FIG. 8 illustrates a portion of the procedure shown in FIG. 6 in more detail.

In step S401, the rearrangement unit 30 acquires the rearrangement sequence information from the rearrangement sequence determination unit 82.

In step S402, the rearrangement unit 30 acquires the deep features output from the deep feature generation unit 20. These deep features are a plurality of frame images that have not been rearranged.

In step S403, the rearrangement unit 30 rearranges the frame images of the deep features acquired in step S402 according to the sequence acquired in step S401.

In step S404, the rearrangement unit 30 outputs the deep features rearranged in step S403. The rearrangement unit 30 passes the deep features to the coding unit 41.

FIG. 9 is a flowchart showing a procedure of processing performed by the realignment unit 50. FIG. 9 illustrates a portion of the procedure shown in FIG. 6 in more detail.

In step S501, the realignment unit 50 acquires the rearrangement sequence information from the rearrangement sequence determination unit 82. This rearrangement sequence was obtained through the procedure shown in FIG. 5.

In step S502, the realignment unit 50 acquires the deep features from the decoding unit 42. These deep features are a plurality of frame images arranged by the rearrangement unit 30.

In step S503, the realignment unit 50 realigns the deep features acquired in step S502 based on the sequence information acquired in step S501. That is, the realignment unit 50 performs rearrangement that is the inverse of the rearrangement performed by the rearrangement unit 30. Through the processing of the realignment unit 50, the sequence of the plurality of frame images is returned to the sequence prior to the rearrangement performed by the rearrangement unit 30.

In step S504, the realignment unit 50 outputs the realigned deep features. The realignment unit 50 passes the realigned deep features to the cloud image processing unit 60.

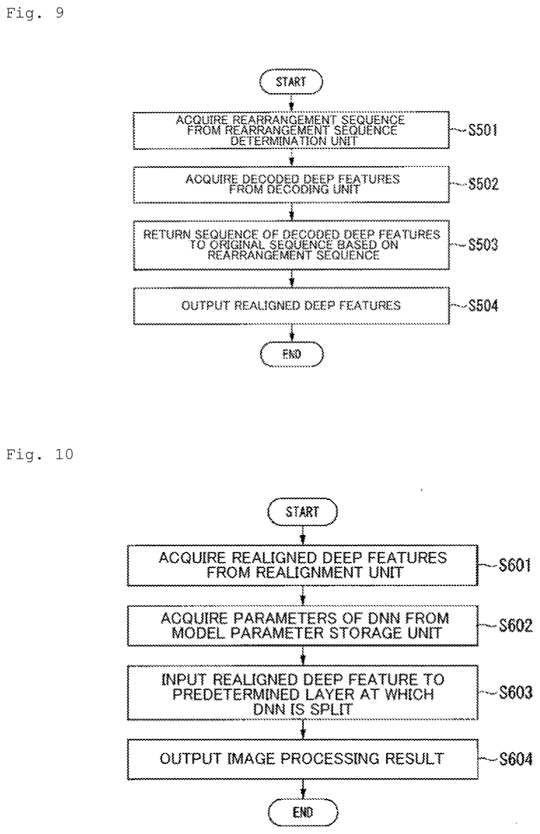

FIG. 10 is a flowchart showing a procedure of processing performed by the cloud image processing unit 60. FIG. 10 illustrates a portion of the procedure shown in FIG. 6 in more detail.

In step S601, the cloud image processing unit 60 acquires the realigned deep features output by the realignment unit 50. These deep features are a plurality of frame images in the sequence output by the deep feature generation unit 20.

In step S602, the cloud image processing unit 60 acquires the model parameters of the multi-layer neural network from the model parameter storage unit 70. The cloud image processing unit 60 uses the weight value of each of the layers from the (m+1)-th layer 61 to the N-th layer 62 in FIG. 2 of this parameter.

In step S603, the cloud image processing unit 60 inputs the realigned deep features acquired in step S601 into the (m+1)-th layer 61, which is the input location to the rear half portion of the split multi-layer neural network. Then, the cloud image processing unit 60 performs forward propagation processing based on the above-described model parameters from the (m+1)-th layer 61 to the N-th layer 62 of the multi-layer neural network.

In step S604, the cloud image processing unit 60 outputs the image processing result obtained as a result of the forward propagation in step S603.

As described above, according to the present embodiment, since the rearrangement sequence determination unit 82 determines the rearrangement sequence in advance, each time the data to be processed (inference image) is input, it is possible to reduce costs for calculating the indices (MSE, etc.) relating to the correlation between frames of the deep features. Also, according to the present embodiment, since the rearrangement sequence determination unit 82 determines the rearrangement sequence in advance, it is possible to reduce the overhead for transmitting the determined rearrangement sequence each time. Also, a neural network that is different from the original neural network is connected downstream of an intermediate layer (m-th layer 22), and the rearrangement sequence determination unit 82 determines a sequence according to which the total of the degrees of similarity between adjacent frames is as large as possible, based on the degree of similarity between frames obtained as a result of performing training processing using the training data. This makes it possible to perform suitable compression coding on the intermediate output data of deep learning while maintaining the accuracy of the data. This also enables deep feature transmission at a relatively low bit rate.

Furthermore, as a side effect, the range of applications for automation of a visual process utilizing an image processing system is expanded.

### Second Embodiment

Next, a second embodiment will be described. Note that description of matters that have already been described in the previous embodiment may be omitted below. Here, matters unique to the present embodiment will be mainly described. In the first embodiment, interframe predictive coding is performed using an image of one channel as one frame. By contrast, in the second embodiment, interframe prediction coding is performed with images for a plurality of channels as one frame.

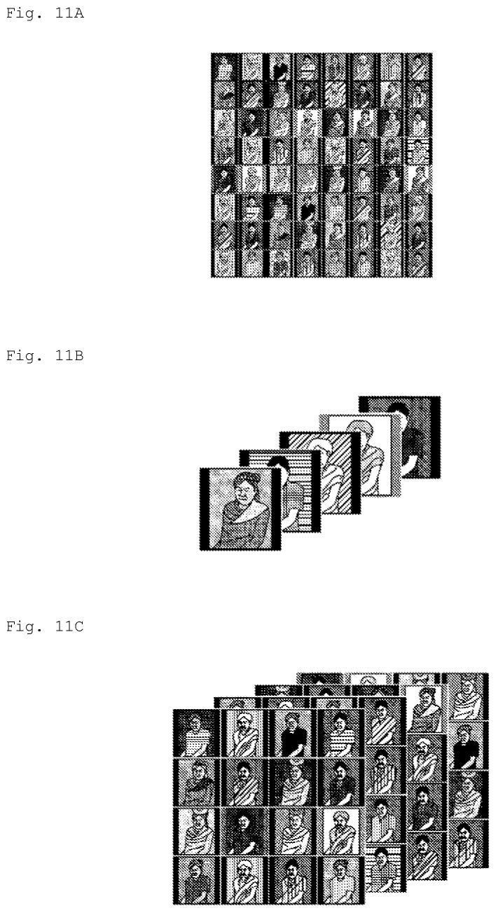

In the first embodiment, the rearrangement unit 30 performed rearrangement and the coding unit 41 performed coding using each channel of the deep features generated by the deep feature generation unit 20 as one frame (see FIG. 11B). However, there is also a problem in that the output resolution of the channel decreases when the layer of the multi-layer neural network becomes deeper. When the output resolution decreases, the efficiency of the intra-frame prediction in the I-frame portion (intra-coded frame), which is coded without using interframe prediction, decreases. In order to solve such a problem, for example, a method of aligning images of a plurality of channels included in a deep feature in one frame and compressing them as an image is conceivable (see FIG. 11A). A method is also conceivable in which images of multiple channels are aligned in one frame and are treated as a moving image composed of multiple frames (see FIG. 11C).

FIGS. 11A, 11B, and 11C are schematic views for illustrating an example of a case in which imaging and animation are performed at the same time. FIG. 11A is a reference example showing a frame image in the case where images for a plurality of channels are compressed and coded as an image of one frame. FIG. 11B is an example (scheme of the first embodiment) showing frame images in the case where interframe predictive coding is performed using an image of one channel as an image of one frame. FIG. 11C shows a frame image in the case where interframe predictive coding is performed on a plurality of frame images while images for a plurality of channels are regarded as an image of one frame (the case of the present embodiment).

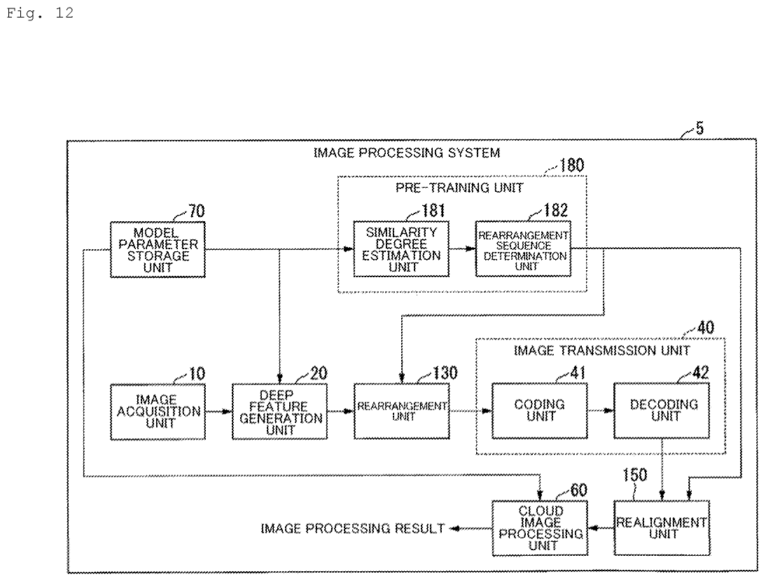

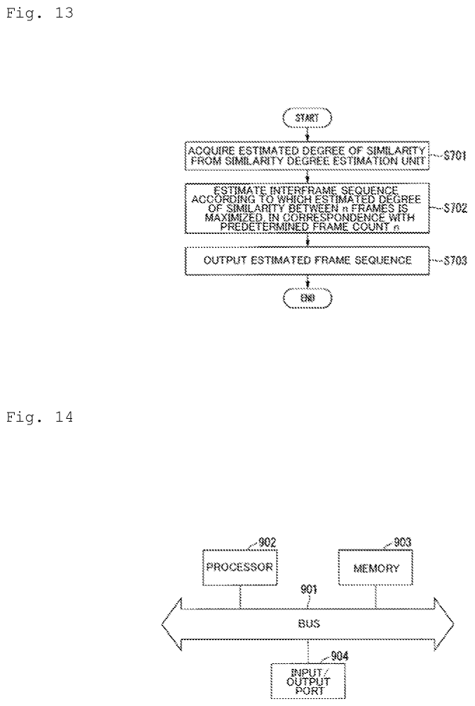

FIG. 12 is a block diagram showing an overview of the overall functional configuration of the second embodiment. As shown in the drawing, the image processing system 5 of the present embodiment has a configuration including an image acquisition unit 10, a deep feature generation unit 20, a rearrangement unit 130, an image transmission unit 40, a realignment unit 150, a cloud image processing unit 60, a model parameter storage unit 70, and a pre-training unit 180. That is, the image processing system 5 of the present embodiment includes the rearrangement unit 130, the realignment unit 150, and the pre-training unit 180 instead of the rearrangement unit 30, the realignment unit 50, and the pre-training unit 80 of the image processing system 1 of the first embodiment.

The rearrangement unit 130 performs processing for rearranging the sequence of frame images including images for a plurality of channels, in units of frames. Note that the rearrangement unit 130 performs rearrangement according to the rearrangement sequence determined by the rearrangement sequence determination unit 182.

The realignment unit 150 performs processing for returning the frame images rearranged by the rearrangement unit 130 to the sequence used prior to the rearrangement. That is, the realignment unit 150 performs realignment in units of frames. The processing performed by the realignment unit 150 is processing that is the inverse of the processing performed by the rearrangement unit 130.

In the present embodiment, when the number of channels is Nc, frame images in which p channel images are included per frame are rearranged. p is an integer that is 2 or more. That is, one frame includes two or more channel images in the intermediate layer (m-th layer). Note that the total number of frames is Nf. That is, when Nc is divisible by p, Nc=p·Nf is satisfied. For example, a single frame image includes channel images aligned in the form of an array in a vertical direction and a horizontal direction. For example, when Nc is not divisible by p, some image (blank image, etc.) instead of a channel image may fill the empty space.

That is, the channel images are Nc images, namely C(1), C(2), . . . , and C(Nc). Also, the frame images are Nf images, namely f(1), f(2), . . . , and f(Nf). At this time, it is possible to fix in advance which channel image is to be arranged in which frame image. The pre-training unit 180 may also determine which channel image is to be arranged in which frame image, through machine learning processing or the like. Also, the positions at which the channel images are to be arranged in the frame image may be fixed in advance. The position at which a channel image is to be arranged in the frame image may also be determined by the pre-training unit 180 through machine learning processing or the like.

The pre-training unit 180 obtains the degree of similarity between frames and determines the rearrangement sequence in units of frames based on the degree of similarity. The pre-training unit 180 includes a similarity degree estimation unit 181 and a rearrangement sequence determination unit 182.

The similarity degree estimation unit 181 estimates the degree of similarity between Nf frame images based on the training data. The method for estimating the degree of similarity is the same as that performed by the similarity degree estimation unit 81 in the previous embodiment.

The rearrangement sequence determination unit 182 determines the rearrangement sequence of the frames based on the degree of similarity between the frames estimated by the similarity degree estimation unit 181. The method for estimating the rearrangement sequence is the same as that performed by the rearrangement sequence determination unit 82 in the previous embodiment. That is, the rearrangement sequence determination unit 182 determines the rearrangement sequence such that the sum of the degrees of similarity between adjacent frames in the rearranged sequence is maximized or is as large as possible. The rearrangement sequence determination unit 182 can use a method of solving the traveling salesman problem when determining the rearrangement sequence.

The rearrangement sequence determination unit 182 can also determine which frame the channel image is to be arranged in by using an algorithm obtained based on maximum matching. The rearrangement sequence determination unit 182 can also determine which position in the frame the channel image is to be arranged at by using an algorithm obtained based on maximum matching.

FIG. 13 is a flowchart showing a procedure of processing of the rearrangement sequence determination unit 82 in the case where imaging and animation are performed at the same time.

First, in step S701, the rearrangement sequence determination unit 182 acquires the estimated degree of similarity from the similarity degree estimation unit 81. The processing of the present step is the same as the processing of step S201 (FIG. 5) in the previous embodiment.

In step S702, the rearrangement sequence determination unit 182 determines the rearrangement sequence. In the processing of the present step, the rearrangement sequence determination unit 182 determines the rearrangement sequence of the frames using at least an algorithm similar to the algorithm for solving the traveling salesman problem, premised on a predetermined frame set. Furthermore, the rearrangement sequence determination unit 182 may also estimate the best frame set itself using an algorithm obtained based on maximum matching. In this case, the similarity degree estimation unit 181 estimates the degree of similarity between frames in the required frame set, and passes it to the rearrangement sequence determination unit 182.

Next, in step S703, the rearrangement sequence determination unit 182 passes the rearrangement sequence determined through the processing of step S702 to the rearrangement unit 30 and the realignment unit 50. The processing of the present step is the same as the processing of step S203 (FIG. 5) in the previous embodiment.

According to the present embodiment, it is possible to avoid a decrease in the efficiency of intraframe prediction even if the layer of the multi-layer neural network becomes deep and the output resolution of the channel decreases.

### MODIFIED EXAMPLES

The first embodiment and the second embodiment can be implemented as the following modified examples. In the modified example, the data to be input to the deep feature generation unit 20 (this will be called “data to be processed”) is not limited to an image (inference image). The data to be processed may be, for example, data indicating any pattern or the like, including audio, map information, game aspects, time-series or spatial arrangements of physical amounts (including temperature, humidity, pressure, voltage, current amount, fluid flow rate, etc.), time series or spatial arrangements of index values and statistical values resulting from societal factors (including indices such as price, exchange rate, interest, and price, population, employment statistics, etc.), and the like. In this modified example, the deep feature generation unit 20 generates deep features of such data to be processed. Also, the rearrangement unit 30 performs rearrangement of the sequence of a plurality of pieces of frame data (which may also be regarded virtually as a frame image) corresponding to the plurality of pieces of channel data included in the deep features, according to a predetermined rearrangement sequence. The coding unit 41 performs compression coding of such frame data, which utilizes the correlation between frames. Even if the modified example is used, the same operations and effects as those of the first embodiment or the second embodiment, which have already been described, can be obtained.

The data processing method according to this modified example includes a plurality of steps listed below. That is, in the first step, the data to be processed is input from the input layer of the neural network, forward propagation in the neural network is performed, and a plurality of pieces of frame data, which each include channel data and are aligned in a predetermined first sequence are acquired as intermediate output values from the intermediate layer, which is a predetermined layer that is not the output layer of the neural network. In the second step, the frame data aligned in the first sequence is rearranged into frame data in the second sequence based on a predetermined rearrangement sequence from the first sequence to the second sequence such that the total of the degrees of similarity between the adjacent frame data in the second sequence is larger than the total of the degrees of similarity between the adjacent frame data in the first sequence. In the third step, the plurality of pieces of frame data rearranged into the second sequence are compressed and coded using a moving image compression coding method performed based on the correlation between the frames.

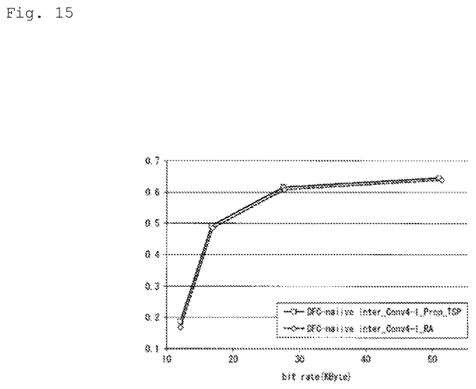

FIG. 14 is a block diagram showing an example of a hardware configuration for realizing each of the plurality of embodiments (including the modified example) that have already been described. The configuration shown in the drawing is a configuration including a bus 901, a processor 902, a memory 903, and an input/output port 904. As shown in the drawing, each of the processor 902, the memory 903, and the input/output port 904 is connected to the bus 901. The constituent elements connected to the bus 901 can exchange signals with each other via the bus 901. The bus 901 transmits those signals. The processor 902 is a processor for a computer. The processor 902 can execute instructions to perform loading from the memory 903. By executing these instructions, the processor 902 reads out data from the memory 903, writes data to the memory 903, and communicates with the outside via the input/output port 904. There is no particular limitation on the architecture of the processor 902. The memory 903 stores a program, which is a string of commands, or data, at least temporarily. The input/output port 904 is a port through which the processor 902 and the like communicate with the outside. That is, data can be input and output to and from the outside and other signals can be exchanged with the outside via the input/output port 904.

With the configuration shown in FIG. 14, it is possible to execute a program having the functions of the embodiments that have already been described.

Any of the plurality of embodiments described above can be realized using a computer and a program. The program implemented in the above-described mode does not depend on a single apparatus, and may perform image conversion processing by recording a program on a computer-readable recording medium, loading the program recorded on the recording medium to a computer system, and executing the program. Note that it is assumed that the term “computer system” as used herein includes an OS and hardware such as peripheral devices. It is assumed that a “computer system” also includes a WWW system including a homepage providing environment (or display environment). Also, the “computer-readable recording medium” refers to a portable medium such as a flexible disk, a magneto-optical disk, a ROM, a CD-ROM, or a DVD-ROM, or a storage device such as a hard disk built in a computer system. Furthermore, it is assumed that a “computer-readable recording medium” also includes a computer-readable recording medium that holds a program for a certain period of time, such as a volatile memory (RAM) inside a computer system that serves as a server or client in the case where a program is transmitted via a network such as the Internet or a communication line such as a telephone line.

The above-described program may also be transmitted from a computer system in which this program is stored in a storage device or the like, to another computer system via a transmission medium or by a transmission wave in the transmission medium. Here, a “transmission medium” for transmitting a program refers to a medium having a function of transmitting information, such as a network (communication network) such as the Internet or a communication line (communication line) such as a telephone line. Also, the above-described program may be for realizing some of the above-mentioned functions. Furthermore, the program may be a so-called difference file (difference program) that can realize the above-described functions in combination with a program already recorded in the computer system.

Although embodiments of the present invention have been described above, it is clear that the above-described embodiments are merely illustrative examples of the present invention, and the present invention is not limited to the above-described embodiments. Accordingly, constituent elements may also be added, omitted, replaced, or otherwise modified without departing from the technical idea and scope of the present invention.

FIG. 15 is a graph of numerical values showing an effect of the embodiment of the present invention. This graph shows the image processing accuracy (vertical axis) with respect to the average (horizontal axis) of a code amount of a compressed deep feature. The dataset is an ImageNet2012 dataset that is commonly used in image identification tasks. The broken line is the result obtained in the case of using the conventional technique. The solid line is the result obtained in the case of rearranging the frames using the first embodiment. As shown in this graph, the image processing (identification) accuracy is slightly higher when the first embodiment is used than when the conventional technique is used, over the entire region of the code amount (horizontal axis). Specifically, the BD rate (Bjontegaard delta bitrate) is 3.3% lower when the first embodiment is used than when the conventional technique is used. That is, it can be understood that the present invention realizes a more favorable compression ratio than the conventional technique.

### INDUSTRIAL APPLICABILITY

The present invention can be used, for example, for analysis of images or other data, or the like. However, the scope of use of the present invention is not limited to the possibilities listed here.

### REFERENCE SIGNS LIST

1 Image processing system
2 Transmission-side apparatus
3 Reception-side apparatus
5 Image processing system
10 Image acquisition unit
20 Deep feature generation unit
21 First layer
22 m-th layer
30 Rearrangement unit
40 Image transmission unit
41 Coding unit
42 Decoding unit
50 Realignment unit
60 Cloud image processing unit
61 (m+1)-th layer
62 N-th layer
70 Model parameter storage unit
80 Pre-training unit
81 Similarity degree estimation unit
82 Rearrangement sequence determination unit
130 Rearrangement unit
150 Realignment unit
180 Pre-training unit
181 Similarity degree estimation unit
182 Rearrangement sequence determination unit
901 Bus
902 Processor
903 Memory
904 Input/output port

1. An image processing method comprising:
a step of inputting an inference image from an input layer of a neural network, performing forward propagation in the neural network, and acquiring an output value of a neuron in an intermediate layer, which is a predetermined layer that is not an output layer of the neural network, as an intermediate output value aligned in a predetermined first sequence;
a step of rearranging the intermediate output value aligned in the first sequence into a second sequence based on a predetermined rearrangement sequence from the first sequence to the second sequence such that a total of degrees of similarity of adjacent intermediate output values in the second sequence is greater than a total of degrees of similarity of adjacent intermediate output values in the first sequence; and
a step of regarding the intermediate output value as a frame, and performing compression coding on a plurality of the intermediate output values rearranged into the second sequence, using a compression coding method based on a correlation between frames.

2. The image processing method according to claim 1, wherein a neural network that is different from the neural network is connected downstream of the intermediate layer and the rearrangement sequence is determined in advance based on a weight of the different neural network, which is obtained as a result of performing training processing using training data.

3. The image processing method according to claim 2, wherein the different neural network is a neural network that performs 1×1 convolution processing.

4. The image processing method according to claim 2, wherein the degree of similarity between the frame images is determined based on the weight of the different neural network.

5. The image processing method according to claim 1, wherein the frame includes two or more channel images in the intermediate layer.

6. (canceled)

7. An image processing apparatus comprising:
a deep feature generation unit configured to input an inference image from an input layer of a neural network, perform forward propagation in the neural network, and output an output value of a neuron in an intermediate layer, which is a predetermined layer that is not an output layer of the neural network, as an intermediate output value aligned in a predetermined first sequence;
a rearrangement unit configured to rearrange the intermediate output value aligned in the first sequence into a second sequence based on a predetermined rearrangement sequence from the first sequence to the second sequence such that a total of degrees of similarity of adjacent intermediate output values in the second sequence is greater than a total of degrees of similarity of adjacent intermediate output values in the first sequence; and
a coding unit configured to regard the intermediate output value as a frame, and perform compression coding on a plurality of the intermediate output values rearranged into the second sequence, using a compression coding method based on a correlation between frames.

8. A program for causing a computer to function as an image processing apparatus including:
a deep feature generation unit configured to input an inference image from an input layer of a neural network, perform forward propagation in the neural network, and output an output value of a neuron in an intermediate layer, which is a predetermined layer that is not an output layer of the neural network, as an intermediate output value aligned in a predetermined first sequence;
a rearrangement unit configured to rearrange the intermediate output value aligned in the first sequence into a second sequence based on a predetermined rearrangement sequence from the first sequence to the second sequence such that a total of degrees of similarity of adjacent intermediate output values in the second sequence is greater than a total of degrees of similarity of adjacent intermediate output values in the first sequence; and
a coding unit configured to regard the intermediate output value as a frame, and perform compression coding on a plurality of the intermediate output values rearranged into the second sequence, using a compression coding method based on a correlation between frames.
